(19) United States
(12) Patent Application Publication
(10) Pub. No.: US 2003/0141225 A1
(43) Pub. Date: Jul. 31, 2003

(54) Method and system for separating and sorting recyclable materials from mixed waste streams

(76) Inventors: Franklin DeWayne Liddle, Slerra Vista, AZ (US); Ottavio Anthony Tassielli, Phoenix, AZ (US)

Correspondence Address: WEISS & MOY PC, 4204 NORTH BROWN AVENUE, SCOTTSDALE, AZ, 85251, US

(21) Appl. No.: 10/058,851

(22) Filed: Jan. 28, 2002

(51) Int. Cl. B04B 5/10

(52) U.S. Cl. 209/18; 209/172; 209/930

(57) ABSTRACT

A method and system for separating and sorting recyclable materials from mixed waste streams provides improved separation and reduced cost in trash and recyclable material processing systems. A low surface-current bath is used within the sorting system to separate materials having a low wet-density, such as plastics and coated paper, from materials having a high wet-density, such as uncoated paper. A novel newspaper separation device using an appropriately-sized gap in a conveying system provides separation of newspaper from other large pieces of recyclable material or trash, while leaving heavier materials on the conveying system for further sorting. An improved plastics separator is included for separating plastics by melting-point range.

### BACKGROUND OF THE INVENTION

1. Field of the Invention

The present invention relates generally to recyclable material processing systems, and more specifically, to a processing system that separates and sorts recyclable materials from mixed waste streams.

2. Background of the Invention

The management of trash or waste in general and solid waste in particular is a critical problem facing municipalities and private industry today. Statistical Figures from a report issued by the United States Environmental Protection Agency (EPA) entitled “Municipal Solid Waste In the United States: 1999 Facts and Figures” demonstrate the magnitude of the problem. The above-referenced report reveals the following:

1) In 1999, U.S. households, institutions and businesses generated about 230 million tons of Municipal Solid Waste (MSW) (commonly referred to as trash or garbage), which is approximately 4.7 lbs. of waste per capita per day.

2) From 1960 to 1999 the production of MSW has increased at a rate of 3 to 4% per year.

3) The EPA has provided a list of preferred strategies for handling the MSW production. Source reduction (including reuse) is the most preferred method, followed by recycling and composting. With disposal in combustion facilities and landfills being the least preferred strategy.

4) As of 1999, 28 percent of MSW in the United States was recovered, recycled or composted, 15 percent was burned, and the remaining 57 percent was disposed of in landfills.

5) A typical MSW composition is:

Paper: 38.1%

Yard Waste: 12.1%

Food Waste: 10.9%

Plastics: 10.5%

Metals: 7.8%

Rubber, Leather, and Textiles: 6.6%

Glass: 5.5%

Wood: 5.3%

Other: 3.2%

Municipalities and private services provide trash collection services for both residential and commercial customers. Typically, most if not all of the collected trash ultimately ends up in landfills or is incinerated, generating environmental pollution and raising the cost of trash disposal. (Across the United States, the percentage is over 70% according to the above-referenced report.)

A large percentage of the total trash collected comprises recyclable material which can be sold or otherwise more economically dispatched, but the difficulty of separating the recyclable material from general trash leads to diminishing returns for the processing facility, thereby limiting the amount of recyclable material extraction that is actually performed by the trash processor. However, recycling is increasingly necessary and economically efficient in light of the cost of raw materials that could otherwise be replaced by recycled material, environmental regulation conformance, landfill costs and the undesirability of combustion due to the resulting atmospheric pollution and generated heat.

Recyclable material must be separated into useful categories for delivery to recyclable materials customers and/or on-site processing of recyclables. Typically the categories are: glass, plastics, paper and metals. The plastics and paper are further separated by type and the glass may be separated by color. Plastics must be separated due to differing compositions. Separation into major categories of resins enables efficient reuse of the plastic materials. Metals must also be separated into ferrous and non-ferrous materials, and paper grades are also sorted in categories of fiber types.

There are many forms of trash processing/recyclable materials processing in place today. The trash collected by the collection service provider may be pre-sorted by residential or other customers (consumers) and collected from separate bins, but typically there will be a percentage of non-recyclable materials present due to improperly performed sorting or improper use of the recyclable materials bin. The non-recyclable portion will typically contain a large quantity of recyclable material, as the consumers will generally not separate all of the recyclable material.

While consumer sorting is presently an important component of the present-day waste processing systems, a consumer-sorted system requires more cooperation by the consumers, and the system may require more collections and collection vehicles than may be economically practical. Therefore, not all communities may ever implement a consumer-sorted systems and therefore have a great need for a system that extracts and sorts recyclables directly from MSW. Further, the broad categories of consumer-sorted recyclables must be further sorted to produce narrower categories for further processing and some categories such as metals may be missed entirely by consumer-sorting schemes.

Alternatively, a collection service provider may collect the recyclable materials mixed with trash and provide complete sorting of recyclable materials from the general trash collected. Complete sorting is the ultimate goal as it reduces the collection requirements, though not necessarily the number of trips required. Complete sorting eliminates the need to separate recyclable materials by the consumer, thus eliminating the risk of improper sorting. The collection service provider using a sorting requires a more sophisticated processing system or greater human labor input at the sorting facility. Additional labor adds to the cost of waste disposal.

While individual systems have been developed for sorting portions of a mixed waste stream, no comprehensive solution is available that can efficiently separate and sort recyclable materials from mixed waste streams. The complexity of the task and the associated labor costs have created an obstacle to separating recyclables from mixed collections, including both municipal solid waste and consumer-sorted recyclables.

Therefore, it would be desirable to provide a method and system for separating and sorting recyclable materials from mixed waste streams. It would further be desirable to provide an method and system that sort and separate recyclable material into useful categories.

### SUMMARY OF THE INVENTION

The above objective of providing separation and sorting of recyclable materials from mixed waste streams is achieved in a method and system. The method separates paper and other materials having a high density when wet, from materials such as plastics that have a low density when wet. A low surface-current bath is included in the system for wetting mixed input material and separating the low wet-density material from the high wet-density material. The low wet-density material is conveyed across the surface of the low surface-current bath and may be assisted by a stream generator that generates an upward-directed current within the bath. The high wet-density material submerges and is extracted from a lower level within the bath. A novel newspaper removal device is included for separating newspaper from larger trash items using a gap sized appropriately to pass larger-sized items of trash while permitting newspapers to fall through the gap. An improved plastics separator is included to separate plastic by melting point range. A novel plastics removal device is included for separating plastic bags from a conveyor using a gap and a compressed air stream directed at the gap. The air stream may be controlled by an image recognition system that detects the presence of the plastic bags.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a pictorial diagram depicting a portion of a system in accordance with an embodiment of the present invention.

FIG. 2 is a pictorial diagram depicting further elements of a system in accordance with an embodiment of the present invention.

FIG. 3 is a pictorial diagram depicting yet further elements of a system in accordance with an embodiment of the present invention.

FIG. 4 is a pictorial diagram depicting a plastics removal and processing system in accordance with an embodiment of the present invention.

FIG. 5 is a pictorial diagram depicting a plastics separator in accordance with an embodiment of the present invention.

### DETAILED DESCRIPTION OF THE EMBODIMENTS

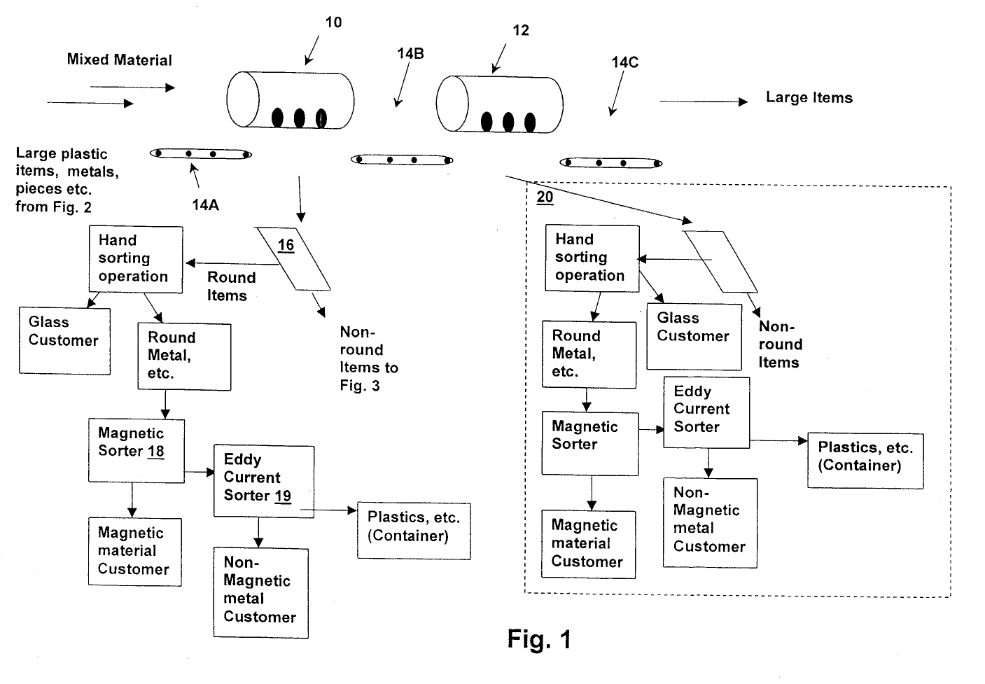

Referring now to the figures and in particular to FIG. 1, a portion of a recyclable material processing system in accordance with an embodiment of the present invention is shown. Mixed material, which may be recyclable materials combined with trash or pre-sorted recyclable materials enter the system at the upper left corner of the diagram. The materials may be preprocessed in a sorting area to remove items that might otherwise cause problems in the system.

A conveyor 14A conducts the mixed material into a rotating cylindrical trommel 10 which has apertures sized to eject material under a predetermined size (generally 6 to 12 inches in diameter). The ejected material may be hand-sorted, or as depicted introduced to an inclined shaker 16 that ejects round objects to a hand-sorting operation. If bagged trash is to be received by the system, a rotating spiked trommel may be used for trommel 10, where internal spikes are welded to the inside wall of trommel 10 in advance of the apertures, so that as bagged trash is introduced, the bags are opened by the spikes.

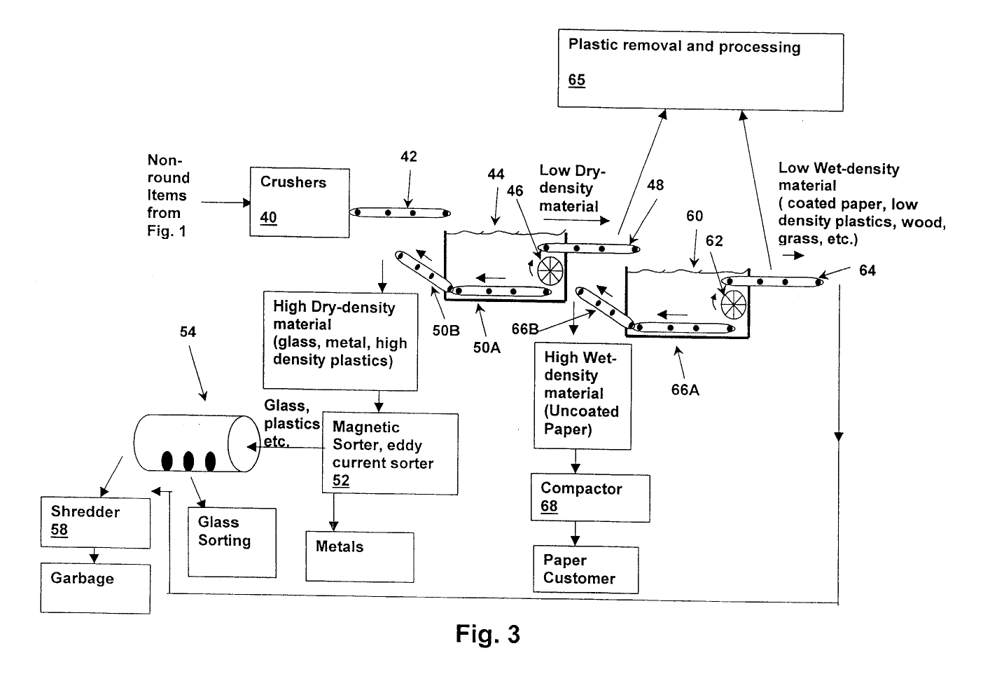

Inclined shaker 16 is a conveyor tilted on an axis perpendicular to the direction of conveyance. A shaker, which is generally a motor or solenoid vibrator table is integrated with a conveyor to physically vibrate the conveyor. As a result, round items tend to move downward along the inclined axis and roll off the inclined shaker before reaching the end of the belt. Non-round items tend to stay on the upward side of the conveyor belt as they move more slowly in the inclined direction and thus are generally conveyed to the end of the conveyor for further sorting by the portion of the system depicted in FIG. 3.

The hand sorting operation receiving the round objects from inclined shaker 16, separates glass bottles from the remainder of the round items. Hand sorting may be performed in a variety of manners using conveyors, tables, bins and other arrangements to provide for personnel safety and facilitate removal of the glass from remaining materials. The glass bottles may be further hand-sorted by color (or potentially sorted by an optical sensing system). The glass bottles are then ground or crushed into an aggregate and stored for delivery to a glass customer.

The other round objects that are ejected from inclined shaker 16 are introduced to a magnetic sorter 18, which separates ferrous metal items (e.g., steel cans) for delivery to a magnetic material customer. The non-ferrous metal items mixed with other round items are passed through an eddy current sorter 19 which separates non-ferrous metal items (e.g., aluminum cans) for delivery to a non-magnetic materials customer. The remaining materials, which are generally plastic bottles are stored for delivery to a plastics customer. The non-round items are conveyed off inclined shaker 16 for further processing by the portion of system depicted in FIG. 3, which is described below.

The entire above-described portion of the system that sorts smaller objects into round and non-round objects is optional and its use dependent on economics, including the composition of the incoming waste and the market price for the recovered materials. Another factor is whether or not the objects are crushed prior to delivery, which would render the use of inclined shaker 16 less feasible.

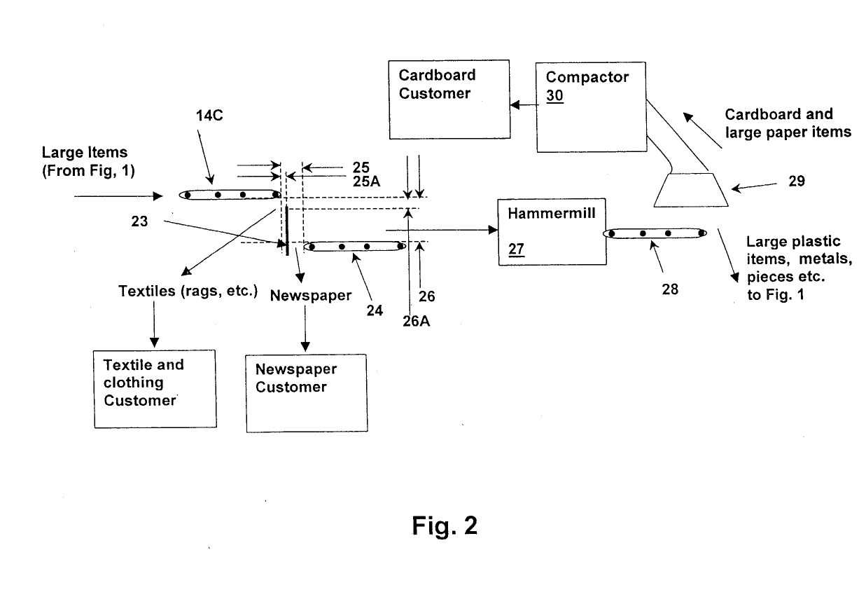

Larger items that were not ejected by trommel 10 are further moved by a conveyor 14B to a second rotating cylindrical trommel 12 which generally will have larger apertures than trommel 10. A second processing system 20 generally identical to the processing system described above (and may share some processing paths and elements such as the metal sorting elements described above) processes the smaller ejected material from trommel 12. A conveyor 14C moves the material not ejected from trommels 10 and 12 to the portion of processing system depicted in FIG. 2. The material moved on conveyor 14C will generally be large plastic items such as buckets and large paper items such as newspapers, cardboard and textiles.

Referring now to FIG. 2, further elements of a recyclable material processing system in accordance with an embodiment of the present invention is shown. Large items not ejected by trommels 10 and 12 of FIG. 1 are conveyed by conveyor 14C to a second conveyor 24. The particular arrangement of conveyor 14C and conveyor 24 provides a newspaper, textile and clothing removal subsystem. A displacement 25 is provided in the horizontal direction and a second displacement 26 is provided in the vertical direction, so that newspaper, textiles and clothing will fall through the gap generated by the displacements, but larger pieces of cardboard and other large items on conveyor 14C will be conducted to conveyor 24. Without this novel mechanism, human operators are required to manually pull newspapers, textiles and clothing from the oversized mixed material on conveyor 14C and thus this improvement in recyclable materials processing systems represents a significant reduction in the cost of recyclable materials processing.

Horizontal displacement 25 is generally twelve inches, so that most cardboard pieces will be carried forward by conveyor 24, while most newspaper, textiles and clothing will fold and fall under their own weight through the gap. Vertical displacement 26 may be from approximately six inches to twelve inches, to provide room for newspapers to pass between conveyor 14C and conveyor 24 to be collected for delivery to a newspaper customer and for textiles and clothing to pass between conveyor 14C and conveyor 24 to be collected for delivery to a textile and clothing customer.

A separator 27 is introduced within the above-described gaps 25 and 26 to separate newspaper from textiles and clothing. As newspaper is generally more rigid than the textiles and clothing, newspaper will be conducted further across horizontal gap 25 before falling. Separator 27 removes textiles and clothing from the end of conveyor 14C (to the left side of separator 27 for delivery to a textile and clothing customer, and may be a divider as shown, a chute, divided conveyor or other suitable means for conducting the textiles and clothing. The horizontal gap 25A between conveyor 14C and separator 27 is generally three inches and the vertical gap 26A between conveyor 14C and the top of separator 27 is generally six inches. The positioning of separator 27 provides that newspaper will be conducted to the right side of separator 27 for delivery to a newspaper customer.

Larger items that are moved past the gap onto conveyor 24 are introduced to a hammermill 27, which flattens and/or breaks the larger items to a manageable size. The materials is then moved from hammermill 27 by a conveyor 28 and a vacuum hood 29 is used to extract cardboard and larger paper items from conveyor 28. The cardboard and larger paper items are provided to a compactor 30, which compacts the material for delivery to a cardboard customer. The pieces of larger plastic items, metal items and other materials that remain on conveyor 28 are reintroduced to the processing system portion of FIG. 1 at the input of trommel 10.

Referring now to FIG. 3, processing of the non-round items conveyed off inclined shaker 16 of FIG. 1 is depicted. Crushers 40 pulverize the material, which is introduced to a bath 44 by a conveyor 42. Bath 44 separates low dry-density material (such as paper and low density plastic) from high dry-density material, such as glass, metal and high density plastic. Low density plastic materials such as low density polyethylene (LDPE), high density polyethylene (HDPE), polypropylene PP) and various foams will float, while high density plastic materials such as polyethyl tetrachloride (PET), polystyrene (PS), acetyl butastyridene (ABS), and poly-vinyl chloride (PVC) will sink. (While HDPE is named “high density” for the purposes of distinguishing among polyethylene formulations in industrial use, HDPE will float in water and therefore within the meaning of density as used to describe the present invention, HDPE is a low density material.)

Bath 44 is a high surface-current bath designed to quickly submerge the high dry-density material while floating the low dry-density material toward the upper surface of bath 44 for removal by a conveyor 48 disposed partially within bath 44. This high surface-current may be assisted by a stream generator 46 depicted as a paddlewheel, but stream generator may be implemented in a variety of manners, such as water jets, air jets, linear paddle arrays or other suitable means for controlling currents within bath 44.

Critical to operation of bath 44 is that paper (which has a low dry-density, but a high wet-density) be conveyed out of bath 44 before it has absorbed too much water and submerges. The submerged material in bath 44 should generally be composed of glass, metal and high density plastics which are removed from bath 44 by conveyors 50A and 50B (a single conveyor may be used) for processing by a glass/metals processing system comprising a magnetic sorter, eddy current sorter 52, and a trammel 54 for sorting glass from other materials. Inclined shaker 16 may be deleted from the system of FIG. 1, in which case the metals processing system in FIG. 3 still provides an alternative path for glass and metal sorting.

Garbage is conveyed through trommel 54 and shredded by a shredder 58, to reduce the liquid content and produce a more compact output for delivery to a landfill or other disposal site. Optionally, a plastics separator (similar to that described below for the processing of low density plastics) may be included before shredder 58 if the volume of high density plastics at the output of trammel 54 is sufficient to justify removing the high density plastics before delivery to a disposal site.

Low dry-density material is removed from near the surface of bath 44 by conveyor 48. A plastic removal and processing system 65 (which will be described in detail below) removes plastic bottles and larger pieces of plastic from conveyor 48. The remaining low dry-density material is introduced to a second bath 60, which sorts low wet-density material (wood, grass cuttings, wax-coated paper, plastic bags etc.) from high wet-density material (generally uncoated paper). Bath 60 is similar in structure to bath 44, but is designed with a lower surface current, so that the high wet-density materials have time to absorb water and submerge. The high wet-density material is removed from bath 60 by conveyors 66A and 66B (which may again be a single conveyor) and is introduced to a compactor 68 in preparation for delivery to a paper customer.

Low wet-density material is removed from bath 60 by a conveyor 64 disposed partially within bath 60 and substantially near the surface of bath 60. Plastic bags are removed from conveyor 64 by plastic removal and processing system 65, and the remaining low wet-density material (generally grass and wood that have floated on the surface of both baths 44 and 60) is sent to shredder 58 along with the garbage left after processing the material from the bottom of bath 44.

Bath 60 provides a novel mechanism for sorting paper from plastics bags and other materials that will generally float indefinitely. The surface current of bath 60 may be controlled with a stream generator 62 which may be paddles or jets as described for stream generator 46 within bath 44, and critical to the operation of bath 60 is that the surface current be maintained at a sufficiently low level that paper will absorb water and submerge sufficiently that conveyor 64 will not extract paper and so that paper will eventually be removed by conveyors 66A and 66B.

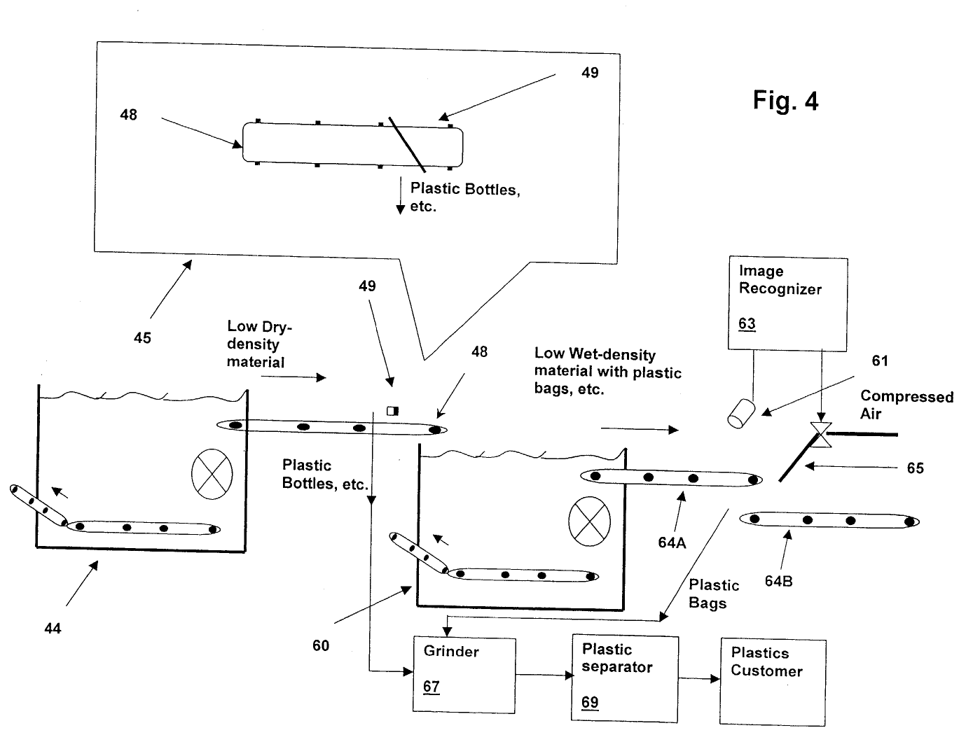

Referring now to FIG. 4, details of plastic removal and processing system 65 are depicted in detail. Plastic bottles leaving crushers 40 of FIG. 3 will generally re-expand to some degree, as the plastic bottles have elastic memory. As described above, plastic bottles are conveyed across the surface of bath 44 and are removed by conveyor 48. A bar 49 set at an angle (between 50 and 80 degrees) with respect to the top surface of conveyor 48 and at a height between 2 and 6 inches, is used to direct plastic bottles and larger pieces of plastic off of conveyor 48 to a grinder 67. The ground plastics are then sorted through a plastic separator 69, and the plastics are stored for delivery to a plastics customer and/or made into usable recycled material products. A top view of the arrangement of bar 49 and conveyor 48 is depicted in callout 45.

Plastic bags and other light pieces of plastic that are conveyed past the bar 49 are introduced to second bath 60 and are conveyed along the surface of second bath 60 and removed by conveyor 64. Conveyor 64 comprises two conveyor segments 64A and 64B, with conveyor 64A disposed above conveyor 64B to generate a gap of approximately 12 inches in height. Compressed air is introduced at an angle opposing gap by a valve/nozzle system 65, which blows plastic bags out of the gap prior to the remaining material reaching conveyor segment 64B. Valve/nozzle system 65 may be a continuous air feed, a timed interval feed, or as depicted, valve/nozzle system 65 may be controlled by an image recognizer 63 coupled to a camera 61 that identifies plastic bags present on conveyor segment 64A and generates a signal to control valve/nozzle system 65 (with an appropriate time delay) to blow the bags through the gap defined between conveyor segments 64A and 64B. The plastic bags are sent to grinder 67 for processing along with the plastic bottles and other large plastic pieces removed from conveyor 48 by bar 49.

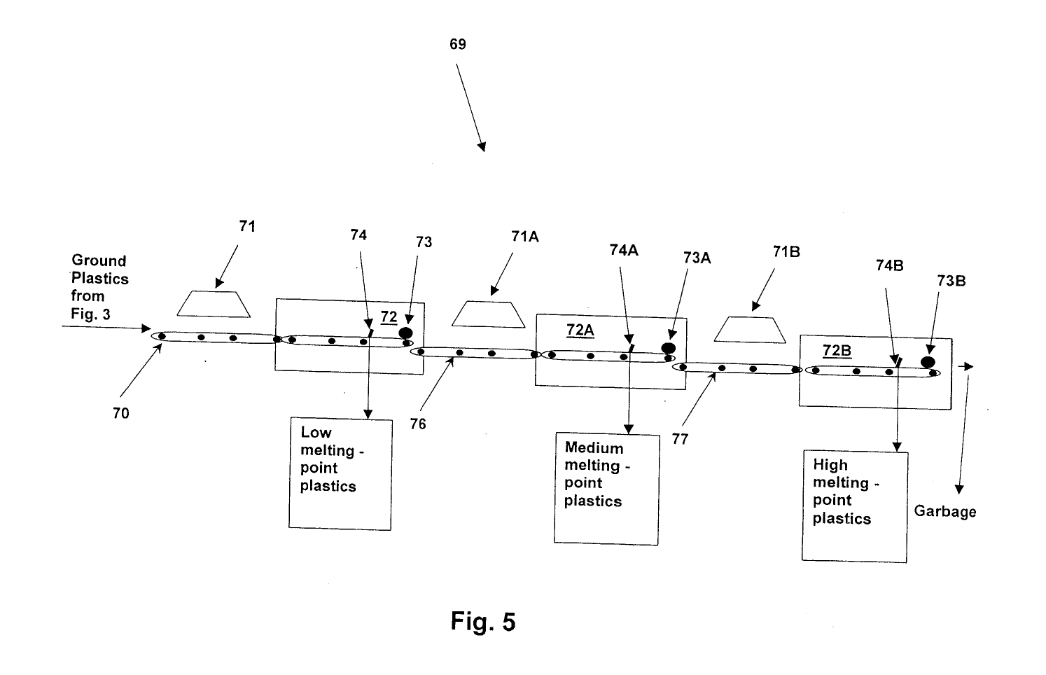

Referring now to FIG. 5, the details of plastics separator 69 are depicted in accordance with an embodiment of the present invention. U.S. Pat. No. 4,892,647, which is incorporated herein by reference, describes a plastic separator using a three-tiered belts system that separates plastics having differing melting points. The plastics adhere to the belts differentially based on their melting points, as the belts are arranged so as to progressively heat thermoplastic materials by adhesion to the belts. The plastics are removed by a scraper at each belt level. Various improvements to the plastic separator described in the above-incorporated patent application are included herein and therefore embody a novel plastic separator.

Plastic separator 69, receives ground plastics from the output of grinder 67 (FIG. 4). A conveyor 70 and preheater 71 are disposed before a first heated conveyor 72 to raise the temperature of the material on the belt to a temperature approaching or equal to the temperature of heated belt system 72. The addition of preheaters to the system described in the above-incorporated patent and the separation of the three-tiered belt system into a cascaded belt system, increases the efficiency of plastics separation achievable in separator 69.

A pinch roller 73 is also included within heated belt system 72 to press the preheated ground plastic pieces onto the belt within heated belt system 72, further improving operation by improving the adhesion of plastic material to the belt within heated belt system 72. Pinch roller 73 is maintained at a temperature lower than that of the heated belt or alternatively is of a material suitably selected so that the plastic material will adhere to heated belt system 72 and not to pinch roller 73. A scraper 74 removes the plastic chips that have adhered or melted onto the belt of heated belt system 72, and the low melting-point plastics are removed for recycled material use. Similarly, the next cascaded stage comprising a preheater 71A and conveyor 76 feeding a second heated belt system 72A removes medium melting-point plastics. Second heated belt system 72A also includes a pinch roller 73A. Scraper 74A removes medium melting-point plastics from second heated belt system 72A.

Finally, a third preheater 71A and conveyor 77 introduce the remaining material to a third heated belt system 72B, which separates high-melting point plastics from the remaining ground garbage. Heated belt system 72B also includes a pinch roller 73B and scraper 74B removes high melting-point plastics from heated belt system 72B. The material that has not adhered to any of the belt systems 72, 72A or 72B (generally grass and wood that have floated on the surface of both baths 44 and 60) is sent to shredder 58 along with the garbage left after processing the material from the bottom of bath 44.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A system for sorting recyclable waste, comprising a low surface-current bath for separating high wet-density material from low wet-density material, wherein said low wet-density material is conveyed across said low surface-current bath, substantially near the surface of said low surface-current bath, and wherein said high wet-density material submerges after entering said bath.

2. The system of claim 1, wherein said low surface-current bath further comprises a stream generator for generating an upward directed current within said low surface-current bath for conveying said low wet-density material near said surface of said low surface-current bath.

3. The system of claim 1, wherein said low surface-current bath further comprises a n upper conveyor disposed within said low surface-current bath and substantially near the surface of said low surface-current bath for collecting said low wet-density material for removal from said low surface-current bath.

4. The system of claim 3, wherein said upper conveyor comprises a first segment and a second segment, wherein said second segment has a first end disposed beneath a second end of said first segment, wherein said first end of said second segment is set beneath said second end of said second segment at a distance defining a vertical gap between said first segment and said second segment, whereby plastic bags are conducted through said gap to a plastics processing system and the balance of said low wet-density material is conveyed past said gap by said second segment.

5. The system of claim 4, further comprising a compressed air feed directed at an angle opposing said gap, whereby said plastic bags are further directed through said gap by said compressed air.

6. The system of claim 5, further comprising an image recognition system disposed above said first conveyor segment an coupled to said compressed air feed for controlling said compressed air feed in response to recognizing plastic bags on said first conveyor segment.

7. The system of claim 1, wherein said low surface-current bath further comprises a lower conveyor disposed within said low surface-current bath with a first end substantially near the bottom of said low surface-current bath for extracting said high wet-density material from said low surface-current bath.

8. The system of claim 1, further comprising a high surface-current bath having an output coupled to an input of said low-surface current bath for separating low dry-density material from high dry-density material, wherein said low dry-density material is conveyed across said high surface-current bath, substantially near the surface of said high surface-current bath, and wherein said high dry-density material submerges after entering said bath.

9. The system of claim 8, wherein said high surface-current bath further comprises a stream generator for generating an upward-directed current within said high surface-current bath for conveying said low dry-density material near said surface of said high surface-current bath.

10. The system of claim 8, wherein said high surface-current bath further comprises an upper conveyor disposed within said high surface-current bath and substantially near the surface of said high surface-current bath for collecting said low dry-density material for removal from said high surface-current bath.

11. The system of claim 10, further comprising a bar disposed above the surface and at an angle with respect to a conveying direction of said upper conveyor for directing plastic bottles and other large plastic pieces to a plastics processing system.

12. The system of claim 8, wherein said high surface-current bath further comprises a lower conveyor disposed within said high surface-current bath with a first end substantially near the bottom of said high surface-current bath for extracting said high dry-density material from said high surface-current bath.

13. The system of claim 1, further comprising:
a trommel for sorting large items of recyclable material including newspaper, textile and clothing from small items of recyclable material;
a first conveyor having a first end for receiving said large items of recyclable material from said trommel;
a second conveyor having a first end disposed beneath a second end of said first conveyor, wherein said first end of said second conveyor is set beneath said second end of said first conveyor at a distance defining a vertical gap between said first conveyor and said second conveyor, whereby said newspaper, textile and clothing is conducted through said gap and the balance of said large items of recyclable material is conveyed past said gap by said second conveyor.

14. A system for sorting recyclable waste, comprising means for separating high wet-density material from low wet-density material.

15. A system for sorting recyclable waste, comprising means for separating high dry-density material from low dry-density material.

16. The system of claim 15, further comprising means for separating high wet-density material from low wet-density material.

17. The system of claim 14, further comprising means for separating newspapers from large items of recyclable material.

18. A method for sorting recyclable waste, comprising:
receiving mixed material containing high wet-density material and low wet-density material;
wetting said mixed material in a bath;
submerging said high wet-density material while floating said low wet-density material;
conveying said low wet-density material across said bath, substantially near the surface of said bath to a receiving destination for said low wet-density material; and
collecting said high wet-density material from said bath.

19. The method of claim 18, further comprising:
receiving primary mixed material containing high dry-density material and low dry-density material;
wetting said primary mixed material in a bath;
submerging said high dry-density material while floating said low dry-density material;
conveying said low dry-density material across said bath, substantially near the surface of said bath to a receiving destination for said low dry-density material, wherein said receiving and wetting of said mixed material is performed on said low dry-density material; and
second collecting said high dry-density material from said bath.

20. A system for sorting recyclable waste, comprising:
a trommel for sorting large items of recyclable material including newspaper, textiles and clothing from small items of recyclable material;
a first conveyor having a first end for receiving said large items of recyclable material from said trommel;
a second conveyor having a first end disposed beneath a second end of said first conveyor, wherein said first end of said second conveyor is set beneath said second end of said first conveyor at a distance defining a vertical gap between said first conveyor and said second conveyor, whereby said newspaper, textile and clothing are conducted through said gap and the balance of said large items of recyclable material is conveyed past said gap by said second conveyor.

21. The system of claim 20, wherein said vertical gap has a length in the range of six inches to twelve inches.

22. The system of claim 20, wherein said second end of said first conveyor and said first end of said second conveyor are displaced horizontally defining a horizontal gap.

23. The system of claim 22, wherein said horizontal gap is substantially equal to twelve inches.

24. The system of claim 20, further comprising a separator positioned between said first conveyor and said second conveyor for separating newspaper from said newspaper textiles and clothing, said separator having a top edge set beneath said second end of said first conveyor and above said first end of said second conveyor, thereby defining a second horizontal gap between said second end of said first conveyor and said separator and a second vertical gap between said second end of said first conveyor and said separator.

25. The system of claim 24, wherein said second horizontal gap is substantially equal to three inches.

26. The system of claim 24, wherein the second vertical gap is substantially equal to six inches.

27. A method of separating newspapers from large items of recyclable materials, said method comprising the steps of:
receiving said newspapers mixed with said large items of recyclable materials;
conducting said received materials on a first conveyor;
further conducting said received material past the end of said first conveyor;
catching said large items of received material on a second conveyor disposed beneath said first conveyor; and
second catching said newspaper from a gap defined by a displacement between said first conveyor and said second conveyor.

28. The method of claim 27, wherein said method further separates textiles and clothing from said large items of recyclable material, wherein said second catching further catches said textiles and clothing from said gap, and wherein said method further comprises separating said newspaper from said textiles and clothing with a separator defining a second gap between said first conveyor and said separator, whereby said textiles and clothing are conducted through said second gap and said newspapers are conducted over said seperator.

29. A system for sorting recyclable waste including a plastic separator for separating thermoplastic materials into collectable fractions, said plastic separator comprising:
a plurality of heated conveyor systems for providing heated adhering surfaces, whereby thermoplastics having a particular melting point range will adhere to a particular one of said plurality of heated conveyor systems; and
a plurality of pinch rollers each opposing an associated one of said heated conveyor systems for causing said particular thermoplastics to adhere to said particular heated conveyor system.

30. A system for sorting recyclable waste including a plastic separator for separating thermoplastic materials into collectable fractions, said plastic separator comprising:
a plurality of heated conveyor systems for providing heated adhering surfaces, whereby thermoplastics having a particular melting point range will adhere to a particular one of said plurality of heated conveyor systems; and
a plurality of preheaters for preheating said thermoplastic materials prior to introduction to an associated one of said heater conveyor systems, wherein each of said preheaters heats said thermoplastic materials to a temperature approaching, but not exceeding the temperature of said associated heated conveyor system.

31. The system of claim 30, wherein said plastic separator further comprises a plurality of pinch rollers each opposing an associated one of said heated conveyor systems for causing said particular thermoplastics to adhere to said particular heated conveyor system.

32. A method of separating thermoplastic materials into collectable fractions, said method comprising:
preheating plastic pieces on a conveyor to a temperature approaching but not exceeding the temperature of a heated conveyor belt;
introducing said plastic pieces to said heated conveyor belt;
scraping thermoplastic materials that have adhered to said heated conveyor belt; and
ejecting materials that have not adhered to said heated conveyor belt.

33. The method of claim 32, further comprising compressing said preheated plastic pieces onto said heated conveyor belt whereby adhesion of said plastic pieces is improved.

34. A method for removing plastic bags from a conveyor transporting mixed recyclable materials, said method comprising:
receiving said mixed recyclable materials;
conducting said received materials on a first conveyor;
further conducting said received materials past an end of said first conveyor;
catching said plastic bags from a gap defined by a displacement between said first conveyor and a second conveyor; and
catching a remainder of said received material on said second conveyor.

35. The method of claim 34, further comprising directing compressed air at said gap to blow said plastic bags through said gap.

36. The method of claim 34, further comprising:
recognizing said plastic bags on said first conveyor; and
controlling a flow of said compressed air in conformity with said recognizing.
